(19) United States
(12) Patent Application Publication
(10) Pub. No.: US 2004/0006943 A1
(43) Pub. Date: Jan. 15, 2004

(54) Manufactured stone product having brick-like installation characteristics

(76) Inventor: Steven H. Weick, Whitney, TX (US)

Correspondence Address: THOMPSON & KNIGHT, L.L.P., PATENT PROSECUTION GROUP, 1700 PACIFIC AVENUE, SUITE 3300, DALLAS, TX, 75201, US

(21) Appl. No.: 10/194,400

(22) Filed: Jul. 12, 2002

(51) Int. Cl. E04C 1/00; B44F 7/00; B44F 9/00; E04C 2/04; E04B 5/04

(52) U.S. Cl. 52/315; 52/612

(57) ABSTRACT

A manufactured stone product having a plurality of cellular concrete blocks is provided. Each block includes at least one surface having a simulated-stone appearance, and the blocks are collectively adapted for installation in a stackable, brick-like installation process. A plurality of block sizes is provided, the blocks preferably having equal depths, but different heights and widths. The different sizes allows the final installation of the cellular concrete blocks to appear more random, similar to a natural stone installation.

### BACKGROUND OF THE INVENTION

1. Field of the Invention

This invention relates generally to manufactured stone and in particular to a manufactured stone product having brick-like installation characteristics.

2. Description of Related Art

Bricks and stone are commonly installed on houses, commercial buildings, and other structures to provide environmental protection, structural support, and attractive exterior surfaces. An advantage associated with brick is the uniformity of size, which allows for ease of installation. Installation of natural stone is more complicated because many different sizes and shapes of stone will typically be used on any particular installation. A stone mason must arrange irregularly shaped and sized stones in an iterative process that requires cutting some of the stones, and then fitting and securing the stones in a random arrangement that is attractive to view.

The cost of installing natural stone is significantly higher than comparable brick installations because of the skill and time required. However, many people prefer the robust, natural look of stone to brick. Although many houses and other buildings have natural stone exteriors, the use of stone has typically been limited to more expensive homes and buildings.

One solution to the high cost of stone has been provided by stone veneers. A stone veneer is typically a thin, flat panel constructed by pouring concrete into a mold. The mold contains at least one surface having a stone-like texture, so the resulting veneer has at least one simulated-stone face. The stone veneers are either manufactured in individual sections, where each simulated stone is separate, or in panels, where each panel contains a plurality of simulated stones. In either case, the stone veneers have a relatively small depth compared to their height and/or width.

Referring to FIG. 5 in the drawings, the installation of a stone veneer 111 is illustrated. A construction wall 113 to which stone veneer 111 is attached in FIG. 5 includes wooden studs 115, plywood sheathing 117, and a weather resistant barrier 119. Insulation material 120 is typically installed between wooden studs 115 to prevent excessive heat transfer between the two sides of construction wall 113. A metal lathe 121 is installed over the weather resistant barrier 119 using corrosion resistant nails or staples, and a scratch coat 123 of mortar is applied to metal lathe 121. After scratch coat 123 has completely set, mortar is applied to a back surface of each stone veneer, and the stone veneer is pressed firmly into place against the scratch coat 123. The newly applied mortar creates a mortar setting bed 127 between scratch coat 123 and the back of stone veneer 111. As stone veneer 111 is pressed into place, fresh mortar squeezes out around the edges of the stone veneer 111, thereby forming a mortar joint 129. The mortar joints 129 between adjacent stone veneers 111 seal the edges of the stone veneers.

Stone veneers are usually installed from the top down in order to keep the lower stone veneers clean. This installation process highlights a significant difference between stone veneer installation and traditional brick laying. When bricks are laid, the bricks are not attached to a metal lathe installed on a construction wall. Instead, the bricks are stacked one on top of the other, with mortar placed in between adjacent bricks. Mortar is not applied between the bricks and the construction wall, and a space is generally left between the construction wall and the stack of bricks. The support for higher bricks is provided by the bricks underneath. The primary support for stone veneer is provided by the mortar bed between the stone veneer and the construction wall. Since the stone veneer is relatively thin compared to the height and width of the veneer, stone veneer installed lower on the construction wall is not designed to vertically support the stone veneer installed above.

Although stone veneers provide one solution to the high cost of installing natural stone, the stone veneers still require a more complicated installation process than traditional brick laying. The veneer installation requires attachment of a metal lathe and application of a mortar scratch coat. These processes require additional skill and increase the total installation time as compared to brick laying. Since bricks are essentially stacked on top of other bricks with mortar placed in between bricks, the installation process is relatively quick and simple. More know-how and time is required to adhere the stone veneer to a vertical construction wall such that the stone veneer remains attached to the wall while the mortar dries. If the mortar consistency is not correct, the stone veneer could fall away from the construction wall before the mortar has dried.

Another problem associated with stone veneer, natural stone, and even traditional bricks is the weight of the products. In order to cover a house or other building, a significant amount of these materials is needed. The associated handling and transportation costs are high, in part, due to the weight of these products. The weight of traditional bricks, stone, and stone veneer also complicates installation at the job site, where the bricks and stone must be moved from the truck to the point of installation. Transportation of the materials on the job site consumes valuable time and manpower, thereby increasing installation costs. Lighter weight materials ease the burden of moving the materials from one place to another and provide significant cost savings.

A need exists, therefore, for a product that provides an attractive stone appearance coupled with a simplified installation process. A need further exists for a stone product that is lightweight and that provides a random look similar to a natural stone installation. Finally, a need exists for a stone product that is easy and inexpensive to manufacture.

### BRIEF SUMMARY OF THE INVENTION

The problems presented in cost effectively providing a stone-like appearance on houses and commercial buildings are solved by the apparatus and methods of the present invention. In accordance with one embodiment of the present invention, a manufactured stone product made of cellular concrete in a block form is provided. The cellular concrete block includes a number of surfaces. At least one of the surfaces has a simulated-stone appearance, and the block is adapted for use in a stackable, brick-like installation process.

The cellular concrete blocks are installed by stacking the blocks on top of and adjacent to other cellular concrete blocks, and mortar is placed between the blocks to secure the blocks in place. In a typical cellular concrete block wall installation, the blocks that are lower in the wall support the weight of the higher blocks. This contrasts with stone veneer, which is installed directly to an existing wall such that the mortar between the stone veneer and the wall supports the weight of the stone veneer.

The cellular concrete blocks are preferably provided in sizes that are equal in depth, but vary in height and length. The different heights and lengths allow installation of the cellular concrete blocks in a more random fashion, which resembles a natural stone installation.

Other objects, features, and advantages of the present invention will become apparent with reference to the drawings and detailed description that follow.

### BRIEF DESCRIPTION OF THE DRAWINGS

FIG. 1 illustrates a perspective view of a manufactured stone product according to the present invention;

FIG. 2 depicts a perspective view of a mold used to manufacture the stone product of FIG. 1;

FIG. 3 illustrates a perspective view of a plurality of the manufactured stone products of FIG. 1 installed adjacent an exterior surface of a building;

FIG. 4 depicts a front view of the manufactured stone products of FIG. 3 installed adjacent an exterior surface of a building;

FIG. 4A illustrates a cross-sectional top view of the manufactured stone products of FIG. 3 installed adjacent an exterior surface of a building; and

FIG. 5 depicts a cross-sectional top view of a prior art stone veneer installation process that is currently used to install stone veneer to an exterior wall of a building.

### DETAILED DESCRIPTION OF THE PREFERRED EMBODIMENT

In the following detailed description of the preferred embodiments, reference is made to the accompanying drawings which form a part hereof, and in which are shown by way of illustration specific preferred embodiments in which the invention may be practiced. These embodiments are described in sufficient detail to enable those skilled in the art to practice the invention, and it is understood that other embodiments may be utilized and that logical mechanical, chemical, and structural changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

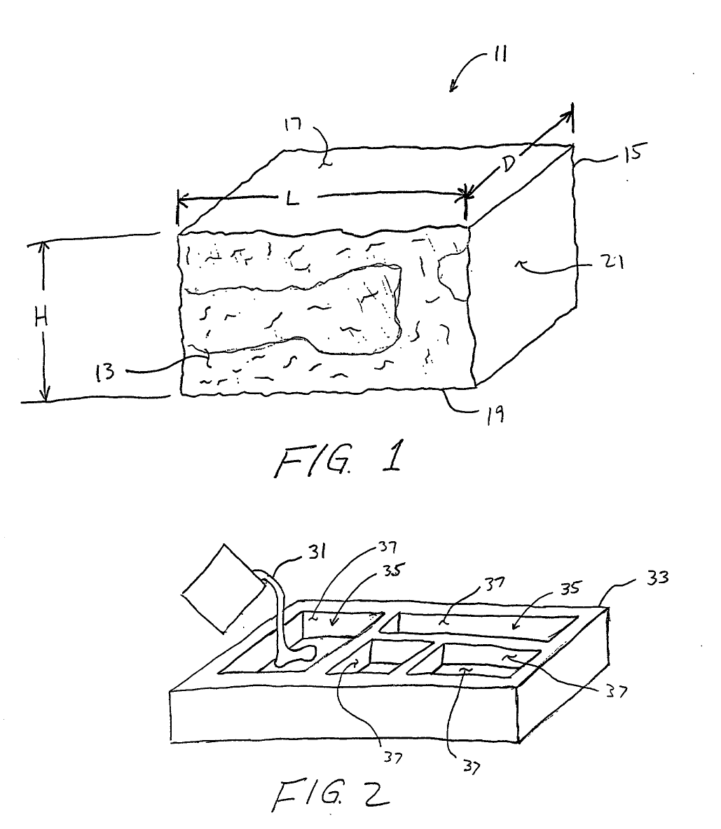

Referring to FIG. 1 in the drawings, a manufactured stone product 11 according to the present invention includes a front surface 13, a rear surface 15, a top surface 17, a bottom surface 19, and two side surfaces 21. The manufactured stone product is block shaped, and each surface of the block is approximately planar and is perpendicular to each adjacent surface. At least one surface of the block 11 has a rough texture that simulates the texture and look of a natural stone. In a preferred embodiment, at least the front surface 13 of the block 111 has the simulated-stone appearance. Even though the rough texture of the simulated-stone surface includes protrusions and indentations, the overall surface could still be considered approximately planar.

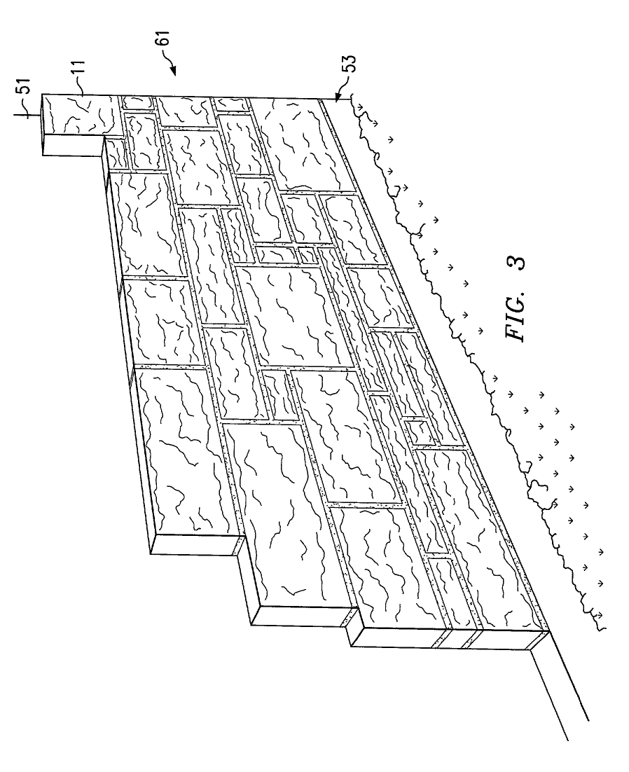

Referring to FIG. 2 in the drawings, block 11 is manufactured by pouring cellular concrete 31 into a mold 33 having at least one cavity 35. Each cavity 35 includes a plurality of walls 37 that together form the cavity 35, and at least one of the walls 37 includes the rough, random texture that will be imparted to block 11. As illustrated in FIG. 2, mold 33 preferably contains different sized cavities 35 to create different sized blocks 11, the advantages of which are explained below. After the cavities have been filled with cellular concrete, the concrete is allowed to sufficiently dry for approximately twenty-four hours, and then the blocks are removed from the mold 33. Although this initial drying time could vary based on temperature and humidity, it should be noted that the concrete is typically not fully cured when removed from the mold 33. After removing from the mold 33, the cellular concrete blocks 11 usually require about twenty-eight days to fully cure.

Cellular concrete 31 creates a strong, yet very lightweight block 11. Cellular concrete is lightweight concrete that contains stable gas cells uniformly distributed in the concrete mixture. The concrete itself is comprised of a mixture of aggregate, sand, and water. Various aggregate types can be used, including without limitation natural or manufactured sand aggregate, expanded clay, shale, slate, sintered fly ash, perlite, vermiculite, pumice, scoria, or tuff. The gas cells, which are usually air cells, are typically added at the mixer as a stable preformed foam that is metered and blended into the concrete mixture. Alternatively, the gas cells may be formed mechanically through high speed mixing of the concrete mixture and a foaming agent, or chemically by mixing chemicals that evolve gas within the mixture. Cellular concretes generally contain macroscopic bubbles as opposed to the microscopic bubbles that are found in air-entrained concrete.

The cellular concrete used to create blocks 11 has a density of approximately 65 pounds per cubic foot, but mixtures having lower or higher densities may be used. Preferably, the constituents of the concrete include 56 weight percent gray cement (type I), 23.9 weight percent sand, 3.4 weight percent cellular foam, and 16.8 weight percent water.

The cellular concrete blocks 11 are manufactured in several different sizes to provide a more random appearance when installed. Before describing actual sizes, however, it is useful to assign a naming convention associated with the dimensions of each block. Referring again to FIG. 1, the length, L, of a block describes the dimensional distance along the front surface of the block that is approximately parallel to the foundation, floor, or ground that supports the weight of the block. The height, H, of a block is the dimensional distance along the front surface of the block that is approximately perpendicular to the floor or ground that supports the weight of the block. It will be noted by a person having skill in the art that the front surface is that surface which is typically displayed in the completed stone wall. In certain cases, simulated-stone textures will be present on additional surfaces of the block, such as one of the side surfaces if the block is installed on a corner of the wall. It will also be appreciated that the length dimension of the block will not always by parallel to the ground, especially when the grounds slopes relative to the block installation. In such cases, the length dimension is better defined as being along the front surface and perpendicular to the force exerted by gravity. The height dimension would be approximately parallel to the gravitational force.

The depth, D, of each block is the dimensional distance that is approximately perpendicular to the length and height dimensions of the block. The depth dimension will typically be the distance between the front surface and rear surface of the block. The preferable depth of each block is 3 inches.

In a preferred embodiment, eleven different cellular concrete blocks 11 are provided. Each of the blocks has depth dimensions that are approximately equal, but the lengths and heights of the blocks vary. While the preferred depth is approximately 3 inches, this dimension could vary. An aspect ratio for each block is defined as the ratio of the depth of the block to the height of the block. Preferably, the aspect ratio of each block does not fall below 25%. The aspect ratio could be below 25%, but the aspect ratio should not decrease to the extent that a first cellular concrete block is unable to support the cellular concrete block installed adjacent to and above the first block.

In Table 1, the preferred height and length dimensions of each block are illustrated along with the frequency of occurrence of each block size relative to other sizes. As illustrated below, the larger blocks are provided with less frequency than the smaller blocks.

TABLE 1

| Brick Dimension (inches) | Frequency |
|---|---|
| 2.25H × 6.5L | 3 |
| 2.25H × x 10L | 4 |
| 5H × 10L | 2 |
| 5H × 13.5L | 4 |
| 5H × 17L | 1 |
| 7.75H × 10L | 1 |
| 7.75H × 13.5L | 2 |
| 7.75H × 17 L | 1 |
| 10.5H × 13.5L | 1 |
| 10.5H × 17 L | 1 |
| 10.5H × 20.5L | 1 |

Although the preferred sizes and frequencies of the cellular concrete blocks 11 have been illustrated above, the sizes and frequencies could vary. It is desirable to have a variety of different heights and lengths so that the installation of the concrete blocks appears more random, similar to a natural stone installation. But it is also desirable to have proportional heights and proportional lengths so that the installation process is simplified, similar to traditional brick laying.

If heights different from those illustrated in Table 1 are to be used, the heights according to one embodiment can be calculated according to the following formula:

Hᵢ=i(0.5BH+0.5M)+BH

where BH is the base height of the smallest cellular concrete block, M is the mortar thickness between blocks, and i=1,2,3 . . . n number of block heights. This selection process for block heights provides many different scenarios for combining shorter blocks and taller blocks in random-appearing installation patterns. For example, two 3 inch tall blocks with a 0.5 inch mortar line can be stacked next to a 6.5 inch tall block. Or a 3 inch tall block and 6.5 inch tall block separated by a 0.5 inch mortar line can be stacked next to a 10 inch tall block.

Of course, a person having skill in the art will recognize that an installer is not required to stack two shorter blocks next to a taller block having a height equal to the shorter blocks and the mortar line. However, the sizing of the blocks allows for this option, thereby simplifying the installation process for installers who are more accustomed to laying brick.

It should also be noted that block sizes for every integer, i, are not required. Some block sizes calculated by the height formula may be skipped. For example, if a base height of 3 inches was used, the next tallest block of 4.75 inches is calculated using an integer of 1. The next block is 6.5 inches tall, which is calculated using an integer of 2. In some design scenarios, it may be desirable to manufacture blocks having heights of 3 inches and 6.5 inches, but omit blocks having heights of 4.75 inches.

If lengths different from those illustrated in Table 1 are to be used, the lengths according to one embodiment can be calculated according to the following formula:

Lⱼ=j(0.5BL+0.5M)+BL

where BL is the base length of the smallest cellular concrete block, M is the mortar thickness between blocks, and j=1,2,3 . . . n number of block lengths. This selection process for block lengths provides many different scenarios for combining shorter blocks and longer blocks in random-appearing installation patterns. For example, two 5 inch blocks with a 0.5 inch mortar line can be stacked above or below a 10.5 inch long block. A 5 inch long block and a 10.5 inch long block separated by a 0.5 inch mortar line can be stacked above or below a 16 inch long block.

Of course, a person having skill in the art will recognize that an installer is not required to stack two shorter blocks adjacent a longer block having a length equal to the shorter blocks and the mortar line. However, the sizing of the blocks allows for this option, thereby simplifying the installation process for installers who are accustomed to laying brick.

It should also be noted that block sizes for every integer, j, are not required. Some block sizes calculated by the height formula may be skipped. For example, if a base length of 5 inches is used, the next longest block of 7.75 inches is calculated using an integer of 1. The next block is 10.5 inches long, which is calculated using an integer of 2. In some design scenarios, it may be desirable to manufacture blocks having lengths of 5 inches and 10.5 inches, but omit blocks having lengths of 7.75 inches.

Although the cellular concrete blocks 11 have been described as having constant depths and varying heights and lengths, it is conceivable that any or all of the dimensions could vary. It is also possible that only one of the dimensions would vary, with the other two dimensions being constant. For example, blocks may be manufactured that have constant depths and lengths, but varying heights. Similarly, blocks may be manufactured having constant depths and heights, but varying lengths.

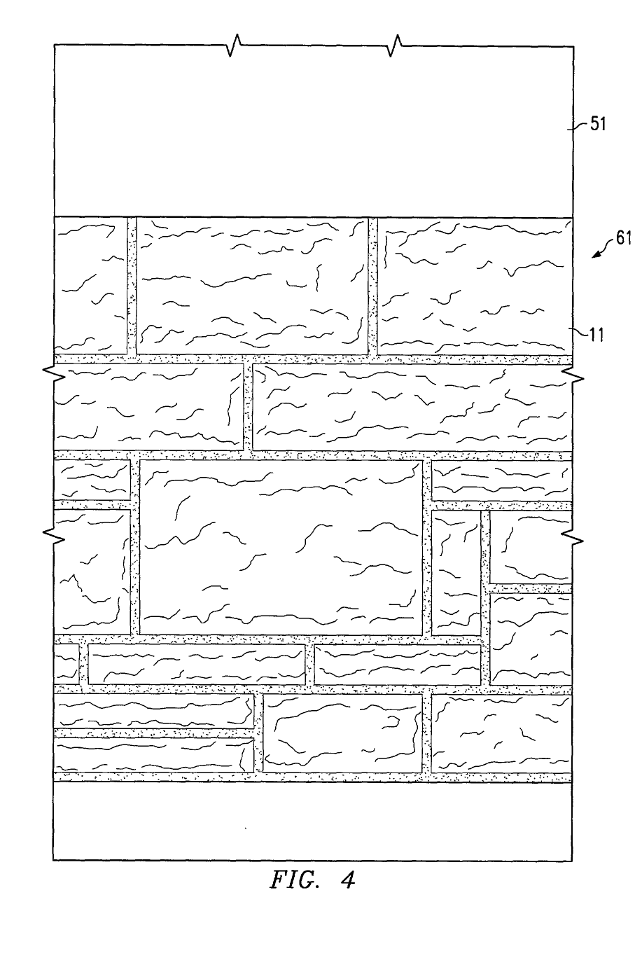

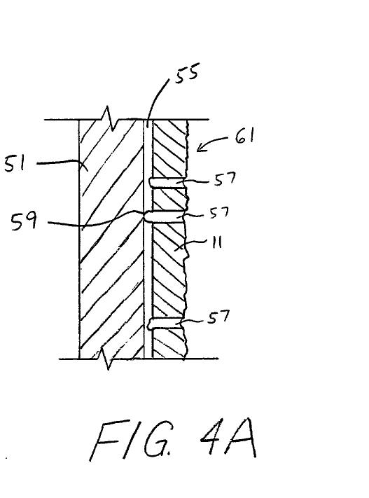

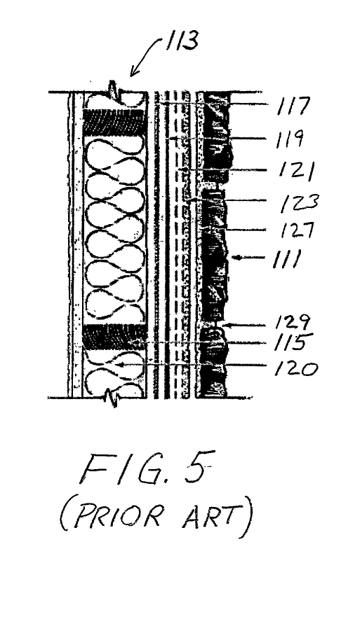

Referring to FIGS. 3 and 4 in the drawings, the installation of cellular concrete blocks 11 on an exterior building wall 51 is illustrated. Building wall 51 is a typical construction wall (similar to construction wall 113 of FIG. 5) and could be made of concrete, wood, or any other material. In a residential application, building wall 51 usually consists of plywood installed over wall studs. A moisture proof barrier may also be provided on the exterior of the plywood surface. Building wall 51 is supported by a foundation slab 53 that protrudes outwardly from underneath building wall 51. Cellular concrete blocks 11 are installed on the protruding portion of foundation slab 53.

Cellular concrete blocks 11 are installed in a stackable, brick-like installation process. An installer applies mortar to the bottom surface 19 of a first block 111 and presses the block into place on the foundation slab 53. The installer applies mortar to the bottom surface and side surface of an adjacent block and presses that block into place on the foundation slab next to the first block. This process is repeated until a row of cellular concrete blocks 11 covers the protruding portion of the foundation slab 53.

Since the blocks 11 on the first row are different heights, additional rows of blocks 11 must be fit into place. The installation process is similar to that described above. The installer applies mortar to the bottom surface 19 and side surfaces 21 of each block before stacking the block on top of and adjacent to blocks that were previously laid. This installation process is repeated until a block wall 61 is completed outside of building wall 51.

Referring to FIG. 4A in the drawings, persons having skill in the art of brick laying will recognize that a small space 55 is usually provided between the building wall 51 and block wall 61. This space increases the insulative properties of the building. Although mortar 57 placed around each block 11 may protrude past the rear surface 15 of the block 111 and actually touch the building wall 51 at some points 59, the building wall 51 does not provide vertical support to the block wall 61. Instead, the weight of blocks 11 comprising the block wall 61 are supported by the blocks 11 underneath and ultimately by foundation slab 53. The stackable installation method, the method of support, and the composition distinguish the manufactured stone product of the present invention from the stone veneers presently used.

It should also be noted that wall ties (not shown) may be anchored between building wall 51 and block wall 61, but the wall ties do not provide meaningful vertical support for the blocks 11 in block wall 61. Instead, the wall ties counteract lateral forces encountered by the block wall 61. In strong wind storms, the wall ties prevent the entire block wall 61 from falling away from or toward building wall 51.

Although the installation of the block wall has been described with reference to the exterior wall of a building (i.e. building wall 51), cellular concrete blocks 11 could be used to create a simulated-stone wall against the interior wall of a building. The simulated-stone wall could also be free standing since the blocks 11 are self-supporting and require no adjacent structure. Simulated-stone fences and barbeque pits are examples of free-standing structures that could be constructed from cellular concrete blocks 11. It should also be noted that a foundation slab is not necessary to support the block walls of the present invention. Since the constituent blocks 11 are made from lightweight cellular concrete, some interior installations may be performed where the blocks 11 are placed directly onto the subfloor of the building. In some exterior installations, the first row of blocks may be placed directly on the ground.

The primary advantage of the present invention is that it provides a lightweight manufactured stone product having brick-like installation characteristics. The cellular concrete used to manufacture the blocks of the present invention contains macroscopic gas bubbles uniformly mixed throughout the concrete. The result is a strong product that is exceptionally light. Since the depth to height aspect ratio of the cellular concrete blocks is high relative to stone veneers, the cellular concrete blocks are configured for stackable installation, similar to traditional brick-laying. The lower cellular concrete blocks in the wall support the weight of the cellular concrete blocks installed above.

The different sizes of cellular concrete blocks provide yet another advantage of the present invention. Since the cellular concrete blocks are supplied in pre-manufactured sizes of varying height and length, a more random installation similar to that of natural stone can be achieved upon installation.

Yet another advantage of the present invention is the ease with which the cellular concrete blocks are manufactured. A mold is provided with at least one cavity in the shape of a desired cellular concrete block. At least one wall of the cavity includes a stone-like surface. Cellular concrete is poured into the mold and allowed to sufficiently dry, and a block is formed that adopts the stone-like texture of the cavity wall.

Even though many of the examples discussed herein are applications of the present invention on houses and commercial buildings, the present invention also can be applied to any application where stone or brick is used, including without limitation barbeque pits, storage sheds, retaining walls, privacy walls, and fences.

It should be apparent from the foregoing that an invention having significant advantages has been provided. While the invention is shown in only a few of its forms, it is not just limited but is susceptible to various changes and modifications without departing from the spirit thereof.

I claim:

1. A manufactured stone product comprising a cellular concrete block having a plurality of surfaces, wherein at least one of the surfaces includes a simulated-stone appearance.

2. A manufactured stone product according to claim 1, wherein the cellular concrete block is adapted for use in a stackable, brick-like installation process.

3. A manufactured stone product according to claim 1, wherein:
the plurality of surfaces includes a front and rear surface, a top and bottom surface, and two side surfaces;
each of the surfaces is approximately planar; and
each surface is approximately perpendicular to adjacent surfaces on the cellular concrete block.

4. A manufactured stone product according to claim 1, wherein the surface having the simulated-stone appearance has a rough, random texture relative to surfaces not having the simulated-stone appearance.

5. A manufactured stone product according to claim 1, wherein the cellular concrete block has a density of approximately 65 pounds per cubic foot.

6. A manufactured stone product according to claim 1, wherein the cellular concrete block includes a mixture of cement, aggregate, sand, water, and gas cells uniformly distributed in the mixture.

7. A manufactured stone product according to claim 6, wherein a preformed foam is blended into the mixture in calibrated amounts to create the gas cells.

8. A manufactured stone product comprising:
a plurality of cellular concrete blocks, each block having front and rear surfaces, top and bottom surfaces, and two side surfaces;
wherein the front surface has a simulated-stone appearance;
wherein a second of the cellular concrete blocks is adapted for installation in a stackable process on a first of the cellular concrete blocks; and
wherein the stackable installation allows the second of the cellular concrete blocks to be supported by the first of the cellular concrete blocks.

9. A manufactured stone product according to claim 8, wherein the cellular concrete blocks are made in a plurality of preformed sizes, resulting in a more random installation of the blocks than with traditional bricks.

10. A manufactured stone product according to claim 8, wherein at least eleven preformed sizes of the cellular concrete blocks are provided.

11. A manufactured stone product according to claim 9, wherein the preformed sizes of the cellular concrete blocks vary in height and length, but have substantially equal depths.

12. A manufactured stone product according to claim 11, wherein the depth to height aspect ratio of each cellular concrete block is at least 0.25.

13. A manufactured stone product according to claim 9, wherein:
the preformed sizes of the cellular concrete blocks vary in height, but have substantially equal lengths and substantially equal depths;
the smallest height of the cellular concrete blocks is represented by the variable BH, the thickness of mortar between the cellular concrete blocks is represented by the variable M, and an incremental counting variable is represented by the variable i; and
the height, represented by the variable H, of additional cellular concrete blocks is calculated using the formula Hᵢ=i(0.5BH+0.5M)+BH.

14. A manufactured stone product according to claim 9, wherein:
the preformed sizes of the cellular concrete blocks vary in length, but have substantially equal heights and substantially equal depths;
the smallest length of the cellular concrete blocks is represented by the variable BL, the thickness of mortar between the cellular concrete blocks is represented by the variable M, and an incremental counting variable is represented by the variable j; and
the length, represented by the variable L, of additional cellular concrete blocks is calculated using the formula Lⱼ=j(0.5BL+0.5M)+BL.

15. A manufactured stone product according to claim 9, wherein:
the preformed sizes of the cellular concrete blocks vary in height and length, but have substantially equal depths;
the smallest height of the cellular concrete blocks is represented by the variable BH, the smallest length of the cellular concrete blocks is represented by the variable BL, the thickness of mortar between the cellular concrete blocks is represented by the variable M, and incremental counting variables are represented by the variables i and j;
the height, represented by the variable H, of additional cellular concrete blocks is calculated using the formula Hᵢ=i(0.5BH+0.5M)+BH; and
the length, represented by the variable L, of additional cellular concrete blocks is calculated using the formula Lⱼ=j(0.5BL+0.5M)+BL.

16. A method of manufacturing a stone product comprising the steps of:
providing at least one mold having a plurality of walls that together form a cavity, wherein at least one of the walls includes a stone-like texture;
pouring cellular concrete into the cavity of the mold to form a cellular concrete block; and
removing the cellular concrete block from the mold after the cellular concrete block has sufficiently dried.

17. A method of manufacturing a stone product according to claim 16, wherein the step of pouring cellular concrete further comprises blending a preformed foam into a mixture of aggregate, sand, and water to provide gas cells uniformly distributed throughout the mixture.

18. A method of manufacturing a stone product according to claim 16, wherein the cellular concrete has a density of approximately 65 pounds per cubic foot.

19. A method of manufacturing a stone product according to claim 16, wherein:
cellular concrete blocks are created that vary in height, but have substantially equal widths and substantially equal depths;
the smallest height of the cellular concrete blocks is represented by the variable BH, the thickness of mortar between the cellular concrete blocks is represented by the variable M, and an incremental counting variable is represented by the variable i; and
the height, represented by the variable H, of additional cellular concrete blocks is calculated using the formula Hᵢ=i(0.5BH+0.5M)+BH.

20. A method of manufacturing a stone product according to claim 16, wherein:
cellular concrete blocks are created that vary in length, but have substantially equal heights and substantially equal depths;
the smallest length of the cellular concrete blocks is represented by the variable BL, the thickness of mortar between the cellular concrete blocks is represented by the variable M, and an incremental counting variable is represented by the variable j; and
the length, represented by the variable L, of additional cellular concrete blocks is calculated using the formula Lⱼ=j(0.5BL+0.5M)+BL.

21. A method of manufacturing a stone product according to claim 16, wherein:
cellular concrete blocks are created that vary in height and length, but have substantially equal depths;
the smallest height of the cellular concrete blocks is represented by the variable BH, the smallest length of the cellular concrete blocks is represented by the variable BL, the thickness of mortar between the cellular concrete blocks is represented by the variable M, and incremental counting variables are represented by the variables i and j;
the height, represented by the variable H, of additional cellular concrete blocks is calculated using the formula Hᵢ=i(0.5BH+0.5M)+BH; and
the length, represented by the variable L, of additional cellular concrete blocks is calculated using the formula Lⱼ=j(0.5BL+0.5M)+BL.
